(19) United States
(12) Patent Application Publication
(10) Pub. No.: US 2020/0386305 A1
(43) Pub. Date: Dec. 10, 2020

(54) Bondable Cooling Fin Arrays for Use on Aircraft Gearboxes

(71) Applicant: Bell Textron Inc., Fort Worth, TX (US)

(72) Inventors: Colton Gilliland, Northlake, TX (US); Tyson T. Henry, Arlington, TX (US)

(73) Assignee: Bell Textron Inc., Fort Worth, TX (US)

(21) Appl. No.: 16/434,142

(22) Filed: Jun. 6, 2019

(51) Int. Cl. F16H 57/04; B64D 35/04; B64C 29/00; B64C 27/82; B64C 27/06; B64C 27/14

(52) U.S. Cl. CPC F16H 57/0416; B64D 35/04; B64C 27/14; B64C 27/82; B64C 27/06; B64C 29/0033

(57) ABSTRACT

A rotorcraft includes a fuselage with at least one rotor assembly coupled thereto. A drivetrain provides rotational energy to the rotor assembly. The drivetrain includes an engine and a gearbox having a gearbox housing. A gearbox cooling fin array including a plurality of cooling fins is bonded to the gearbox housing with a thermal interface material. The gearbox cooling fin array is configured to dissipate heat generated by the gearbox during operation of the rotorcraft.

### TECHNICAL FIELD OF THE DISCLOSURE

The present disclosure relates, in general, to heat sinks or cooling fins for use on aircraft and, in particular, to cooling fin arrays that are bondable to various components of an aircraft such as a gearbox housing.

### BACKGROUND

Aircraft components can generate significant heat during operation. For example, aircraft drivetrain components including the engine, motor and/or transmission are in constant motion during operation, which creates friction that generates heat. In the case of an aircraft gearbox, moving gears heat the surrounding lubrication such as oil by conduction and convection. Heat is then transferred to the housing containing the heated oil by similar processes. If aircraft components overheat, they are susceptible to damage or failure. Aircraft often employ cooling subsystems to prevent overheating of aircraft components. Many currently employed cooling subsystems are liquid or air based.

For example, liquid based cooling subsystems may pump a liquid through cavities in an engine to absorb the heat generated by components of the engine. Liquid based cooling subsystems, however, often require heavier and more complex components such as a power source and hydraulic pump. One type of air based cooling subsystem is a heat sink, which includes cooling fins. Heat sinks utilize convection to dissipate heat from the component of which they are a part by allowing airflow between and around the cooling fins. Currently, such cooling fins are integrally and permanently machined or cast with the aircraft component they are intended to cool. It has been found, however, that integrally machining or casting cooling fins on an aircraft component is difficult and time-consuming. Because the aircraft component and cooling fins must be manufactured using the same manufacturing technique, current cooling fins are unable to utilize different manufacturing techniques to optimize cooling fin geometry or cover complex component surfaces. In addition, permanently machined or cast cooling fins increase maintenance costs by requiring both the cooling fins and the integral component structure to be replaced when one or more of the cooling fins is damaged.

### SUMMARY

In a first aspect, the present disclosure is directed to a drivetrain for an aircraft including a gearbox having a gearbox housing, a gearbox cooling fin array having a plurality of cooling fins and a thermal interface material bonding the gearbox cooling fin array to the gearbox housing. The gearbox cooling fin array is configured to dissipate heat generated by the gearbox.

In some embodiments, the gearbox may be a spiral bevel gearbox. In certain embodiments, the gearbox housing may form a curved surface and the gearbox cooling fin array may include a curved gearbox cooling fin array to contour the curved surface of the gearbox housing. In some embodiments, the gearbox housing may be formed from a different material than the gearbox cooling fin array. In certain embodiments, the gearbox cooling fin array may be formed from a more thermally conductive material than the gearbox housing. In some embodiments, the gearbox cooling fin array may include copper. In certain embodiments, the gearbox cooling fin array may be extruded. In some embodiments, the gearbox cooling fin array may be flexible or rigid.

In certain embodiments, the gearbox cooling fin array may be segmented. In such embodiments, each segmented gearbox cooling fin array may be bonded to the gearbox housing using the thermal interface material. In certain embodiments, the cooling fins may include pin fins, splayed fins or parallel fins. In some embodiments, the thermal interface material may include thermally conductive particulates. In certain embodiments, the thermal interface material may form a bond line between the gearbox cooling fin array and the gearbox housing having a depth in a range between 0.005 inches and 0.01 inches.

In a second aspect, the present disclosure is directed to a rotorcraft including a fuselage, a rotor assembly coupled to the fuselage and a drivetrain providing rotational energy to the rotor assembly. The drivetrain includes an engine and a gearbox coupled to the engine. The gearbox includes a gearbox housing. The drivetrain also includes a gearbox cooling fin array including a plurality of cooling fins and a thermal interface material bonding the gearbox cooling fin array to the gearbox housing. The gearbox cooling fin array is configured to dissipate heat generated by the gearbox.

In some embodiments, the rotorcraft may be a tiltrotor aircraft that includes a wing supported by the fuselage and rotatable pylon assemblies coupled to the outboard ends of the wing. In such embodiments, the gearbox may be a spiral bevel gearbox located in one of the rotatable pylon assemblies. In certain embodiments, the gearbox may be a parallel axis gearbox, a helicopter main rotor gearbox or a tail rotor gearbox.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1C are schematic illustrations of a tiltrotor aircraft including gearbox cooling fin arrays in accordance with embodiments of the present disclosure;

FIG. 2 is an isometric view of a gearbox housing having cooling fins formed integrally therewith;

FIGS. 3A-3B are isometric and side views of a gearbox cooling fin array in accordance with embodiments of the present disclosure;

FIGS. 4A-4B are isometric views of gearbox cooling fin arrays in accordance with embodiments of the present disclosure;

FIGS. 5A-5D are schematic illustrations of a tiltrotor aircraft including gearbox cooling fin arrays in accordance with embodiments of the present disclosure;

FIGS. 6A-6C are various views of a parallel axis gearbox having cooling fins formed integrally therewith;

FIG. 7 is an isometric view of a parallel axis gearbox including gearbox cooling fin arrays in accordance with embodiments of the present disclosure; and

FIGS. 8A-8E are schematic illustrations of a helicopter including gearbox cooling fin arrays in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

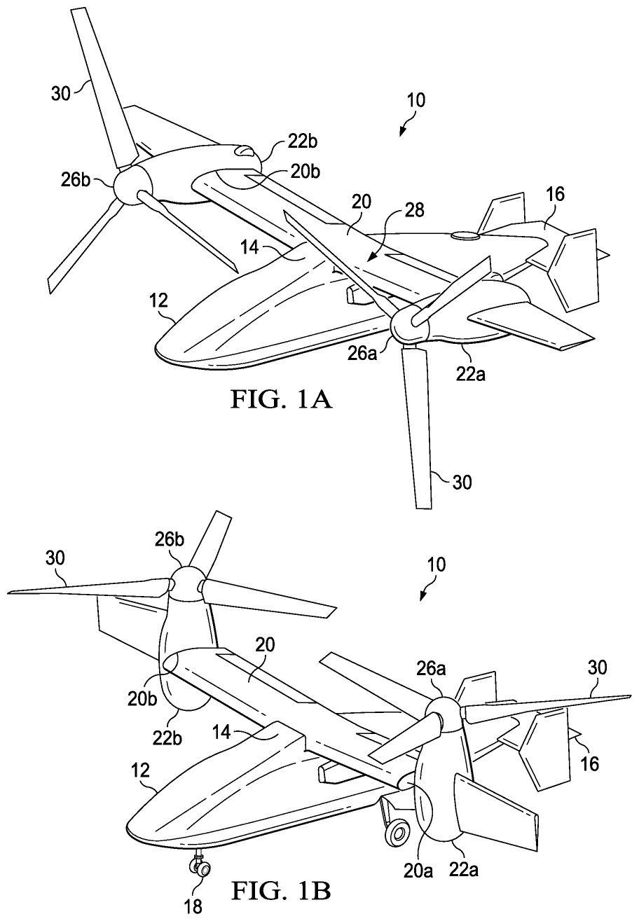

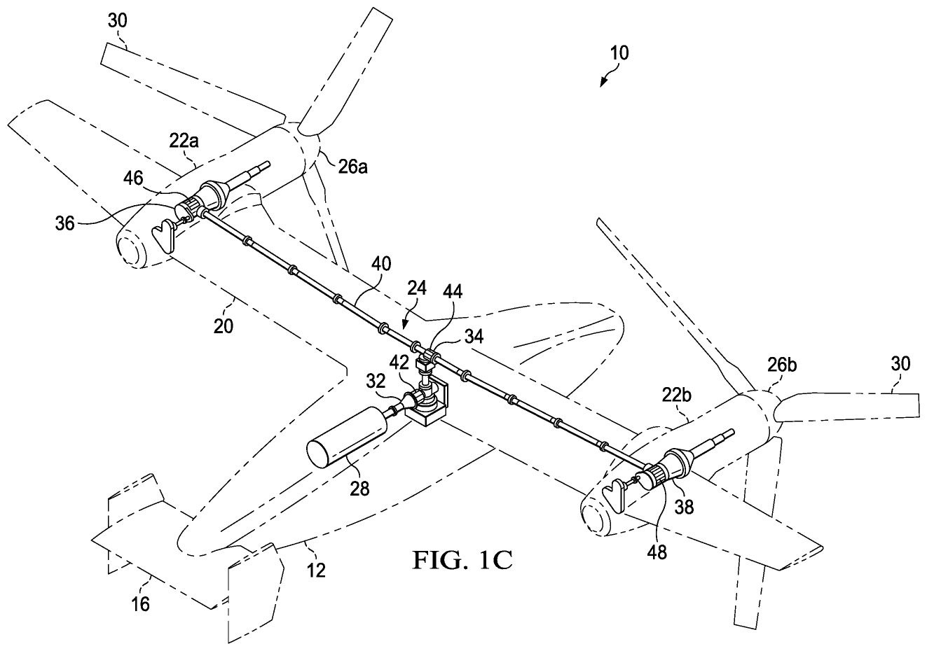

Referring to FIGS. 1A-1C in the drawings, a tiltrotor aircraft is schematically illustrated and generally designated 10. Tiltrotor aircraft 10 includes a fuselage 12, a wing mount assembly 14 and a tail assembly 16. Tail assembly 16 may have control surfaces operable for horizontal and/or vertical stabilization during flight. A landing gear system 18 provides ground support for tiltrotor aircraft 10. A wing 20 is supported by fuselage 12 and wing mount assembly 14.

Coupled to outboard ends 20a, 20b of wing 20 are pylon assemblies 22a, 22b. Pylon assembly 22a is rotatable relative to wing 20 between a generally horizontal orientation, as best seen in FIGS. 1A and 1C, and a generally vertical orientation, as best seen in FIG. 1B. Pylon assembly 22a includes a rotatable portion of a drivetrain 24 and a proprotor assembly 26a that is rotatable responsive to torque and rotational energy provided by an engine or motor 28 of drivetrain 24. Likewise, pylon assembly 22b is rotatable relative to wing 20 between a generally horizontal orientation, as best seen in FIGS. 1A and 1C, and a generally vertical orientation, as best seen in FIG. 1B. Pylon assembly 22b includes a rotatable portion of drivetrain 24 and a proprotor assembly 26b that is rotatable responsive to torque and rotational energy provided by engine 28 of drivetrain 24. In the illustrated embodiment, proprotor assemblies 26a, 26b each include three proprotor blade assemblies 30. It should be understood by those having ordinary skill in the art, however, that proprotor assemblies 26a, 26b could alternatively have a different number of proprotor blade assemblies, either less than or greater than three. In addition, it should be understood that the position of pylon assemblies 22a, 22b, the angular velocity or revolutions per minute (RPM) of proprotor assemblies 26a, 26b, the pitch of proprotor blade assemblies 30 and the like may be controlled by the pilot of tiltrotor aircraft 10 and/or a flight control system to selectively control the direction, thrust and lift of tiltrotor aircraft 10 during flight.

FIGS. 1A and 1C illustrate tiltrotor aircraft 10 in a forward flight mode or airplane flight mode, in which proprotor assemblies 26a, 26b are positioned to rotate in a substantially vertical plane and provide a forward thrust while a lifting force is supplied by wing 20 such that tiltrotor aircraft 10 flies much like a conventional propeller driven aircraft. FIG. 1B illustrates tiltrotor aircraft 10 in a vertical takeoff and landing (VTOL) flight mode or helicopter flight mode, in which proprotor assemblies 26a, 26b are positioned to rotate in a substantially horizontal plane and provide a vertical thrust such that tiltrotor aircraft 10 flies much like a conventional helicopter. During operation, tiltrotor aircraft 10 may convert from helicopter flight mode to airplane flight mode following vertical takeoff and/or hover. Likewise, tiltrotor aircraft 10 may convert back to helicopter flight mode from airplane flight mode for hover and/or vertical landing. In addition, tiltrotor aircraft 10 can perform certain flight maneuvers with proprotor assemblies 26a, 26b positioned between airplane flight mode and helicopter flight mode, which can be referred to as conversion flight mode.

Tiltrotor aircraft 10 uses drivetrain 24 including engine 28 and a transmission subsystem including gearboxes 32, 34, 36, 38 for providing torque and rotational energy to each proprotor assembly 26a, 26b via one or more drive shafts 40 located in wing 20. Gearboxes 32, 34 are located in fuselage 12 and gearboxes 36, 38 are located in pylon assemblies 22a, 22b. In the illustrated embodiment, gearboxes 32, 34, 36, 38 are spiral bevel gearboxes, although drivetrain 24, and tiltrotor aircraft 10 generally, may employ any type of gear or gearbox such as a helical gearbox, coaxial helical inline gearbox, bevel helical gearbox, skew bevel helical gearbox, worm reduction gearbox, planetary gearbox, spur gearbox or any other assembly utilizing gears. In other embodiments, each pylon assembly 22a, 22b houses a drive system, such as an engine, motor and/or transmission subsystem, for supplying torque and rotational energy to a respective proprotor assembly 26a, 26b. In such embodiments, the drive systems of each pylon assembly 22a, 22b may be coupled together via one or more drive shafts located in wing 20 such that either drive system can serve as a backup to the other drive system in the event of a failure. In tiltrotor aircraft having both pylon and fuselage mounted drive systems, the fuselage mounted drive system may serve as a backup drive system in the event of failure of either or both of the pylon mounted drive systems.

The various components of drivetrain 24 may generate heat during operation, especially those components that experience high amounts of friction such as engine 28 and gearboxes 32, 34, 36, 38. Tiltrotor aircraft 10 may employ liquid and/or air based cooling subsystems to reduce the temperature of, and avoid damage to, these components. For example, an engine cooling subsystem may pump cooling liquid through engine 28. Additionally, gearboxes 32, 34, 36, 38 may contain lubrication such as oil to reduce the friction and heat therein. Drivetrain 24 may also utilize airflow for cooling purposes by including gearbox cooling fin arrays 42, 44, 46, 48, which are bonded to gearboxes 32, 34, 36, 38, respectively. Each gearbox cooling fin array 42, 44, 46, 48 includes cooling fins that dissipate heat generated by gearboxes 32, 34, 36, 38. In addition to spiral bevel gearboxes, gearbox cooling fin arrays 42, 44, 46, 48 may be bonded to any type of gearbox including, but not limited to, helical gearboxes, coaxial helical inline gearboxes, bevel helical gearboxes, skew bevel helical gearboxes, worm reduction gearboxes, planetary gearboxes, spur gearboxes or any other assembly utilizing gears. It will be appreciated by one of ordinary skill in the art that gearbox cooling fin arrays 42, 44, 46, 48 may be employed for aircraft components other than gearboxes including any component for which air cooling or heat dissipation is desired, such as engine 28.

It should be appreciated that tiltrotor aircraft 10 is merely illustrative of a variety of aircraft that can implement the embodiments disclosed herein. Indeed, gearbox cooling fin arrays 42, 44, 46, 48 may be implemented on any aircraft. Other aircraft implementations can include hybrid aircraft, tiltwing aircraft, quad tiltrotor aircraft, unmanned aircraft, gyrocopters, propeller-driven airplanes, compound helicopters, drones, jets, helicopters and the like. As such, those skilled in the art will recognize that gearbox cooling fin arrays 42, 44, 46, 48 can be integrated into a variety of aircraft configurations. It should be appreciated that even though aircraft are particularly well-suited to implement the embodiments of the present disclosure, non-aircraft vehicles and devices can also implement the embodiments.

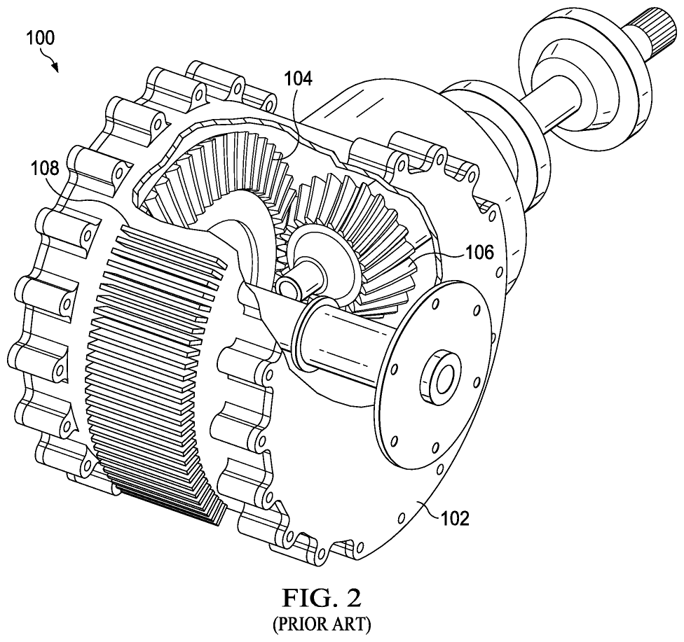

Referring to FIG. 2 in the drawings, a spiral bevel gearbox is schematically illustrated and generally designated 100. Spiral bevel gearbox 100 includes a gearbox housing 102 that contains gears 104, 106. To reduce the friction generated by gears 104, 106, gears 104, 106 are lubricated by oil. The heat generated by rotating gears 104, 106 is transferred to the oil by conduction and convection. The heat is then transferred to gearbox housing 102 by similar processes. To dissipate heat from gearbox housing 102, gearbox housing 102 has been permanently cast with cooling fins 108 formed integrally thereon. Gearbox housing 102 and cooling fins 108 may also have been integrally machined, instead of cast, from the same substrate. Because cooling fins 108 are integral with gearbox housing 102, gearbox housing 102 and cooling fins 108 are formed from the same material. Whether machined or cast, cooling fins 108 are permanently integrated with gearbox housing 102 from the time gearbox housing 102 is manufactured and cannot be removed except by structurally breaking them from gearbox housing 102. Heat from gearbox housing 102 is transferred to cooling fins 108. Air flows through and around cooling fins 108 to dissipate the heat therefrom by convection.

There are several problems with permanently casting or machining cooling fins 108 integrally with gearbox housing 102. For example, cooling fins 108 may be difficult or time-consuming to machine or cast. Machining in particular is limited in its capability to produce complex structures in a timely manner. It may be even more difficult to cast or machine cooling fins 108 integrally with complex surfaces such as the curved surfaces of spiral bevel gearbox 100. Integrally-formed cooling fins 108 are also disadvantaged from a maintenance perspective since, in the event that one or more cooling fins 108 should break, an entirely new gearbox housing 102 is required to return spiral bevel gearbox 100 back to its full cooling capacity.

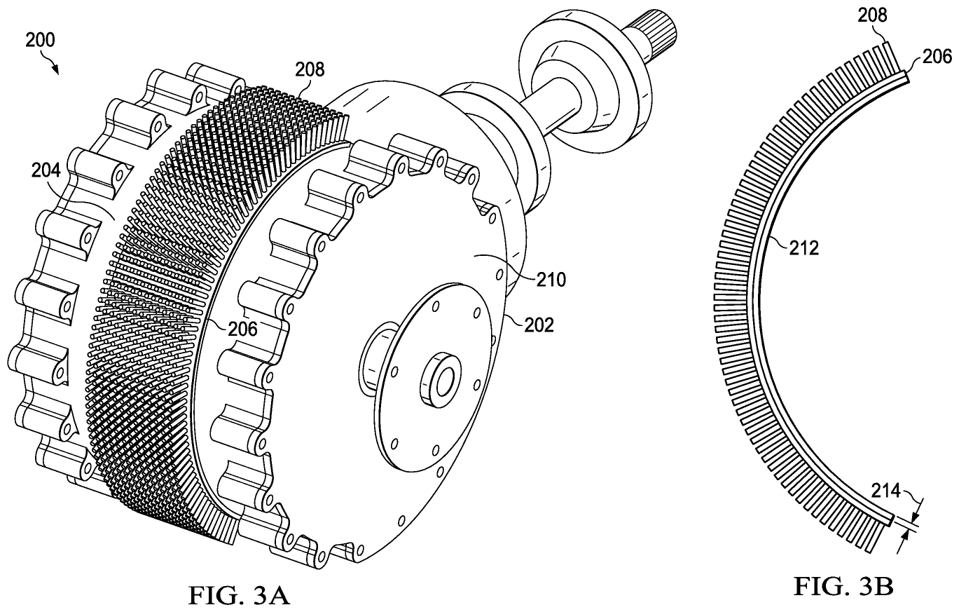

Referring to FIGS. 3A-3B in the drawings, a spiral bevel gearbox is schematically illustrated and generally designated 200. Spiral bevel gearbox 200 includes a gearbox housing 202 having a curved surface 204 to which gearbox cooling fin array 206 has been coupled to dissipate heat generated by spiral bevel gearbox 200. Gearbox cooling fin array 206 has been manufactured separately from gearbox housing 202 and applied onto gearbox housing 202 after both components have been separately manufactured. Thus, gearbox cooling fin array 206 may be coupled to gearbox housing 202, removed from gearbox housing 202 and/or replaced by a different gearbox cooling fin array. Gearbox cooling fin array 206 includes pin fins 208. Pin fins 208 are arranged in rows and columns but may be arranged in other configurations as well. Pin fins 208 have a uniform height, uniform density and are uniformly spaced. In other embodiments, however, pin fins 208 may have nonuniform heights, densities and/or spacing. Pin fins 208 are also cylindrical. In other embodiments, however, pin fins 208 may be tapered and/or have a cross-sectional shape other than a circle such as a polygon, ellipse or irregular shape. Because gearbox cooling fin array 206 is curved to contour curved surface 204 of gearbox housing 202, pin fins 208 are nonparallel and instead have a splayed configuration. Although gearbox cooling fin array 206 is curved, spiral bevel gearbox 200 may also include flat or straight gearbox cooling fin arrays applied to one or more flat surfaces 210 of gearbox housing 202.

Gearbox cooling fin array 206 is bonded to gearbox housing 202 using a thermal interface material 212. Thermal interface material 212 not only bonds gearbox cooling fin array 206 to gearbox housing 202 but also increases the thermal conductivity between gearbox housing 202 and gearbox cooling fin array 206. In some embodiments, thermal interface material 212 may include thermally conductive particulates to increase the thermal conductivity of the bond line between gearbox housing 202 and gearbox cooling fin array 206. Depth 214 of the bond line formed by thermal interface material 212 may also be varied to optimize heat transfer and lower the thermal resistance between gearbox housing 202 and gearbox cooling fin array 206. In one non-limiting example, depth 214 of the bond line may be in a range between 0.0001 inches and 0.4 inches such as a subrange between 0.005 inches and 0.01 inches. Indeed, depth 214 of the bond line may vary widely depending on the desired thermal conduction properties. Bond line may have a uniform or nonuniform depth along its length. Gearbox cooling fin array 206 may alternatively be snapped onto gearbox housing 202 or fastened onto gearbox housing 202 using fasteners such as screws or pins in addition to, or in lieu of, being bonded using thermal interface material 212.

Gearbox cooling fin array 206 may be manufactured using any additive, subtractive or formative manufacturing technique including, but not limited to, extrusion, machining, 3D printing, stamping, welding or casting as well as others. One of the benefits of the illustrative embodiments is the ability to separately manufacture gearbox housing 202 and gearbox cooling fin array 206 using different manufacturing techniques. For example, if gearbox housing 202 is machined, gearbox cooling fin array 206 may be extruded to allow for more complex fin geometries that provide optimal surface area. Thus, gearbox housing 202 and gearbox cooling fin array 206 may be separately manufactured using the most suitable manufacturing technique for each component, thereby simplifying the manufacturing process and increasing manufacturing speed. Because gearbox housing 202 and gearbox cooling fin array 206 are not integrally formed, gearbox cooling fin array 206 may be formed from a different, more thermally conductive material than gearbox housing 202. For example, if gearbox housing 202 is formed from aluminum or magnesium, gearbox cooling fin array 206 may be formed from neither of these materials and instead be formed from a superior thermal conducting material such as copper. In yet other embodiments, gearbox cooling fin array 206 may be formed from or contain aluminum or any other metal as well as nonmetal thermally conductive materials. The material from which gearbox cooling fin array 206 is formed may be chosen based on a number of factors including weight and cooling performance. Using a thin bond line and a copper gearbox cooling fin array 206 can achieve superior gearbox cooling than is possible with integral aluminum fins on an aluminum gearbox housing.

Gearbox cooling fin array 206 may be rigid, bendable or flexible. Flexible gearbox cooling fin arrays may be formed from a flexible or elastic material. Using the illustrative embodiments, several parameters including fin geometry, fin material, manufacturing techniques and the composition or amount of thermal interface material 212 may be adjusted to provide optimal heat transfer between gearbox housing 202 and gearbox cooling fin array 206. Gearbox cooling fin array 206 may also be removed from gearbox housing 202 and replaced with another gearbox cooling fin array in the case of damage thereto, which is less costly and time-consuming than replacing an entire gearbox housing. Optionally, an air blower may be used to blow air across pin fins 208 to assist in the dissipation of heat from spiral bevel gearbox 200.

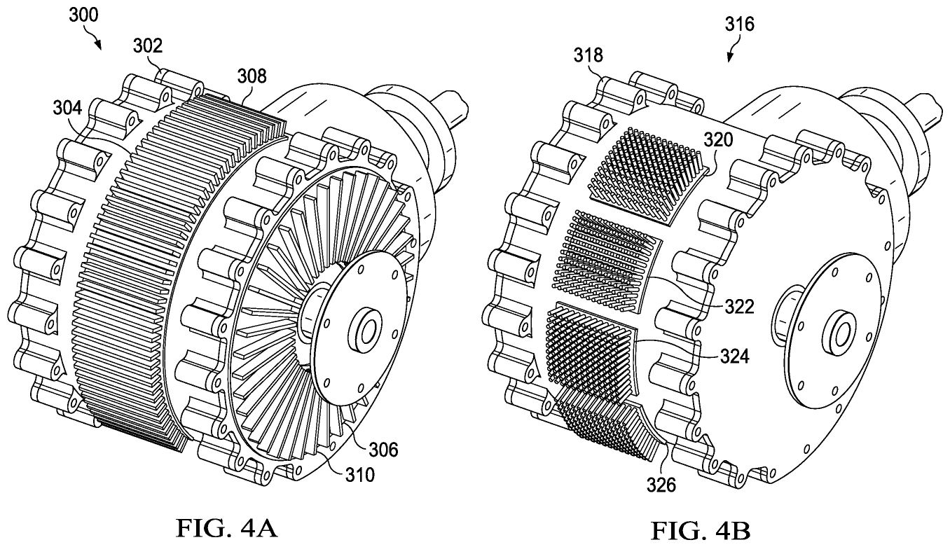

Referring to FIGS. 4A-4B in the drawings, spiral bevel gearboxes having gearbox cooling fin arrays are schematically illustrated. In FIG. 4A, spiral bevel gearbox 300 includes a gearbox housing 302 partially covered by a curved gearbox cooling fin array 304 and a flat gearbox cooling fin array 306 that may be bonded to gearbox housing 302 using a thermal interface material. Instead of pin fins, gearbox cooling fin arrays 304, 306 have elongated fins 308, 310. Elongated fins 308 are arranged as a single row across curved gearbox cooling fin array 304 and elongated fins 310 have a radial configuration around flat gearbox cooling fin array 306. Elongated fins 308, 310 may have any height, thickness, spacing or density. Elongated fins 308, 310 may also have any elongated shape and may be tapered or untapered.

In FIG. 4B, spiral bevel gearbox 316 includes gearbox housing 318 partially covered by segmented gearbox cooling fin arrays 320, 322, 324, 326. Each segmented gearbox cooling fin array 320, 322, 324, 326 includes pin fins similar to pin fins 208 in FIGS. 3A-3B. Each segmented gearbox cooling fin array 320, 322, 324, 326 may be bonded to gearbox housing 318 using a thermal interface material. Segmented gearbox cooling fin arrays may be preferable for complex gearbox housing geometries since small and simple segmented gearbox cooling fin arrays may be easier to manufacture than a larger, more complex gearbox cooling fin array. Gearbox housing 318 may include any number of segmented gearbox cooling fin arrays of any size or shape. Each segmented gearbox cooling fin array 320, 322, 324, 326 may have a different fin geometry. For example, segmented gearbox cooling fin array 320 may have elongated fins while segmented gearbox cooling fin arrays 322, 324, 326 may have pin fins.

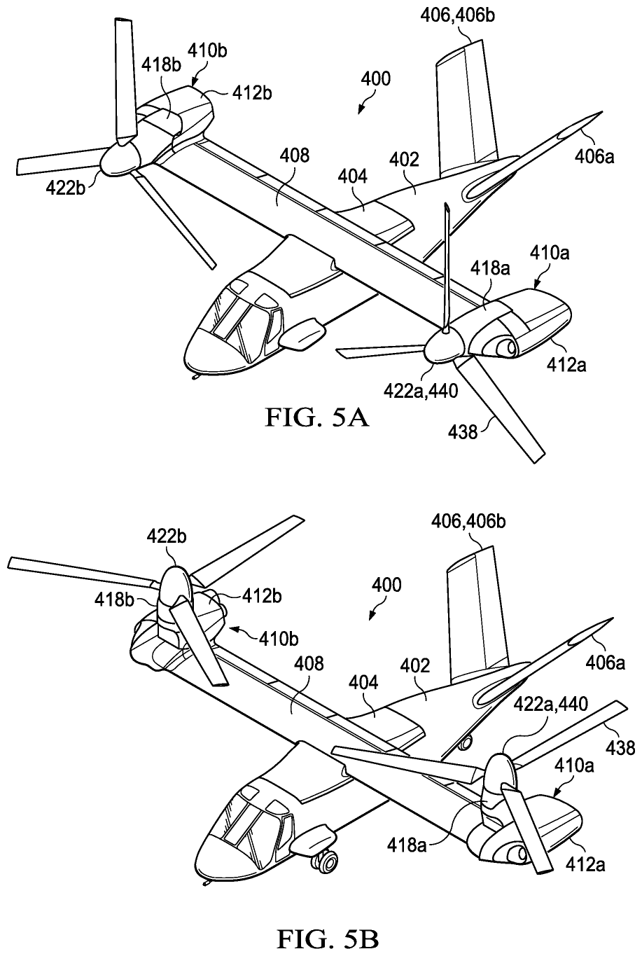

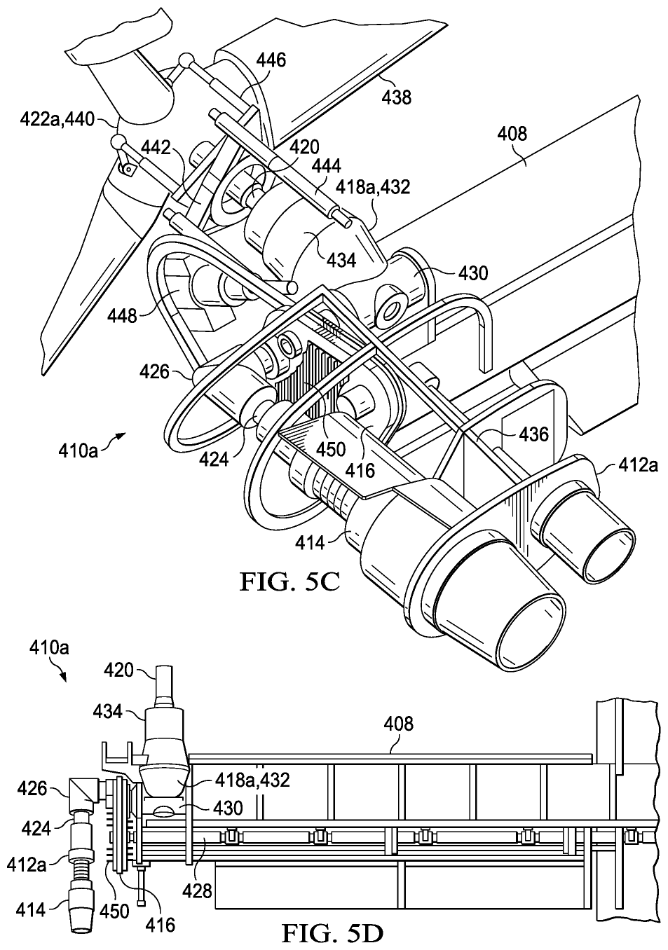

Referring to FIGS. 5A-5D in the drawings, a tiltrotor aircraft is schematically illustrated and generally designated 400. Tiltrotor aircraft 400 includes a fuselage 402, a wing mount assembly 404 and a tail assembly 406 including rotatably mounted tail members 406a, 406b having control surfaces operable for horizontal and/or vertical stabilization during forward flight. A wing member 408 is supported by wing mount assembly 404. Coupled to outboard ends of wing member 408 are propulsion assemblies 410a, 410b. Propulsion assembly 410a includes a nacelle depicted as fixed pylon 412a that houses an engine 414 and a transmission including parallel axis gearbox 416. Thus, the nacelle is fixed relative to wing member 408. In addition, propulsion assembly 410a includes a mast assembly 418a including a mast 420 that is rotatable relative to fixed pylon 412a, wing member 408 and fuselage 402 between a generally horizontal orientation, as best seen in FIGS. 5A, 5C and 5D, and a generally vertical orientation, as best seen in FIG. 5B. Propulsion assembly 410a also includes a proprotor assembly 422a, including proprotor blade assemblies radiating therefrom, which is rotatable responsive to torque and rotational energy provided via a rotor hub assembly and drive system mechanically coupled to engine 414 and parallel axis gearbox 416. Similarly, propulsion assembly 410b includes a nacelle depicted as fixed pylon 412b that houses an engine and transmission and a mast assembly 418b that is rotatable relative to fixed pylon 412b, wing member 408 and fuselage 402. Propulsion assembly 410b also includes a proprotor assembly 422b, including proprotor blade assemblies radiating therefrom, which is rotatable responsive to torque and rotational energy provided via a rotor hub assembly and drive system mechanically coupled to the engine and transmission housed by fixed pylon 412b.

FIG. 5A illustrates tiltrotor aircraft 400 in airplane or forward flight mode, in which proprotor assemblies 422a, 422b are rotating in a substantially vertical plane to provide a forward thrust enabling wing member 408 to provide a lifting force responsive to forward airspeed, such that tiltrotor aircraft 400 flies much like a conventional propeller driven aircraft. FIG. 5B illustrates tiltrotor aircraft 400 in helicopter or vertical takeoff and landing (VTOL) flight mode, in which proprotor assemblies 422a, 422b are rotating in a substantially horizontal plane to provide a lifting thrust, such that tiltrotor aircraft 400 flies much like a conventional helicopter. It should be appreciated that tiltrotor aircraft 400 can be operated such that proprotor assemblies 422a, 422b are selectively positioned between forward flight mode and VTOL flight mode, which can be referred to as a conversion flight mode. Even though tiltrotor aircraft 400 has been described as having one engine in each fixed pylon 412a, 412b, it should be understood by those having ordinary skill in the art that other engine arrangements are possible and are considered to be within the scope of the present disclosure including, for example, having a single engine which may be housed within fuselage 402 that provides torque and rotational energy to both proprotor assemblies 422a, 422b.

Referring now to FIGS. 5C and 5D, propulsion assembly 410a is disclosed in further detail. Propulsion assembly 410a is substantially similar to propulsion assembly 410b therefore, for sake of efficiency, certain features will be disclosed only with regard to propulsion assembly 410a. One having ordinary skill in the art, however, will fully appreciate an understanding of propulsion assembly 410b based upon the disclosure herein of propulsion assembly 410a. Engine 414 of propulsion assembly 410a is substantially fixed relative to wing 408. An engine output shaft 424 transfers power from engine 414 to a spiral bevel gearbox 426 that includes spiral bevel gears to change torque direction by 90 degrees from engine 414 to parallel axis gearbox 416 via a clutch. Parallel axis gearbox 416 includes a plurality of gears, such as helical gears, in a gear train that are coupled to an interconnect drive shaft 428 and a quill shaft (not visible) that supplies torque to an input in spindle gearbox 430 of proprotor gearbox 432, a portion of which may include mast bearing assembly 434. Interconnect drive shaft 428 provides a torque path that enables a single engine of tiltrotor aircraft 400 to provide torque to both proprotor assemblies 422a, 422b in the event of a failure of the other engine. In the illustrated embodiment, interconnect drive shaft 428 includes a plurality of segments that share a common rotational axis.

Engine 414 is housed and supported in fixed pylon 412a (see FIGS. 5A and 5B) that may include features such as an inlet, aerodynamic fairings and exhaust, as well as other structures and systems to support and facilitate the operation of engine 414. The airframe of tiltrotor aircraft 400, which supports the various sections of tiltrotor aircraft 400 including fuselage 402, includes a propulsion assembly airframe section 436 that supports propulsion assembly 410a. Proprotor assembly 422a of propulsion assembly 410a includes three rotor blade assemblies 438 that are coupled to a rotor hub 440. Rotor hub 440 is coupled to mast 420, which is coupled to proprotor gearbox 432. Together, spindle gearbox 430, proprotor gearbox 432 and mast 420 are part of mast assembly 418a that rotates relative to fixed pylon 412a. In addition, it should be appreciated by those having ordinary skill in the art that mast assembly 418a may include different or additional components, such as a pitch control assembly depicted as swashplate 442, actuators 444 and pitch links 446, wherein swashplate 442 is selectively actuated by actuators 444 to selectively control the collective pitch and the cyclic pitch of rotor blade assemblies 438 via pitch links 446. A linear actuator, depicted as conversion actuator 448 of fixed pylon 412a, is operable to reversibly rotate mast assembly 418a relative to fixed pylon 412a, which in turn selectively positions proprotor assembly 422a between forward flight mode, in which proprotor assembly 422a is rotating in a substantially vertical plane, and VTOL flight mode, in which proprotor assembly 422a is rotating in a substantially horizontal plane. Gearbox cooling fin array 450 is bonded to parallel axis gearbox 416 to dissipate heat therefrom. Spiral bevel gearbox 426, spindle gearbox 430 and/or proprotor gearbox 432 may also be at least partially covered by one or more gearbox cooling fin arrays. In yet other embodiments, any of the components of propulsion assembly 410a such as engine 414 may include one or more gearbox cooling fin arrays.

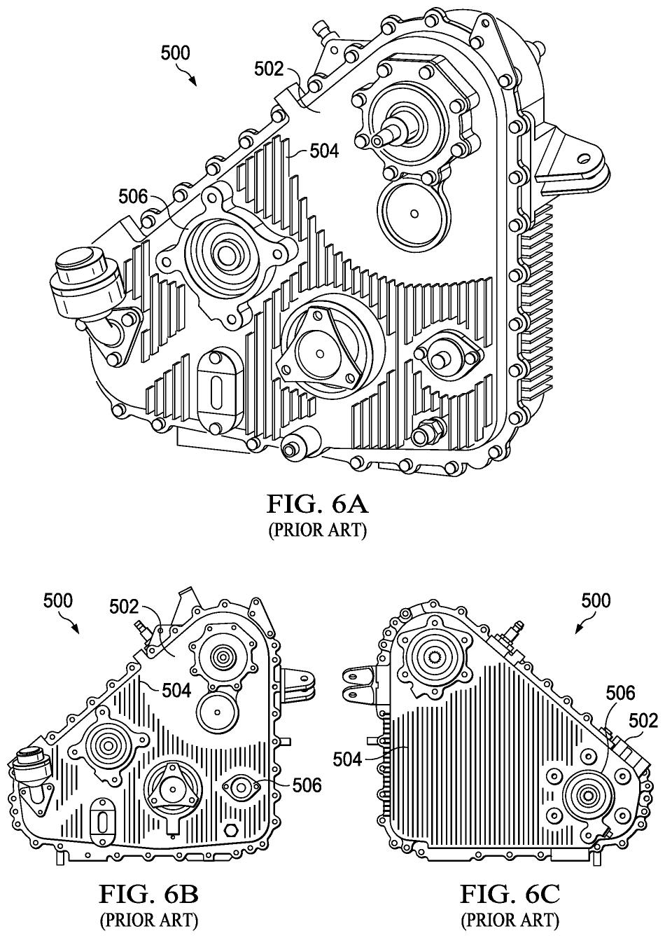

Referring to FIGS. 6A-6C in the drawings, a parallel axis gearbox is schematically illustrated and generally designated 500. Parallel axis gearbox 500 includes a gearbox housing 502 integrally manufactured with cooling fins 504. Because cooling fins 504 are integrally formed with gearbox housing 502 using the same manufacturing process, gearbox housing 502 and cooling fins 504 must be formed from the same material and are inseparable from one another. The coverage area of cooling fins 504 has a complex shape to provide surface coverage around certain protruding features 506 of parallel axis gearbox 500. This leads to some cooling fins 504 being small and easily breakable. Should one of the small fins break, however, the entire gearbox housing 502 must be replaced to return to full cooling functionality.

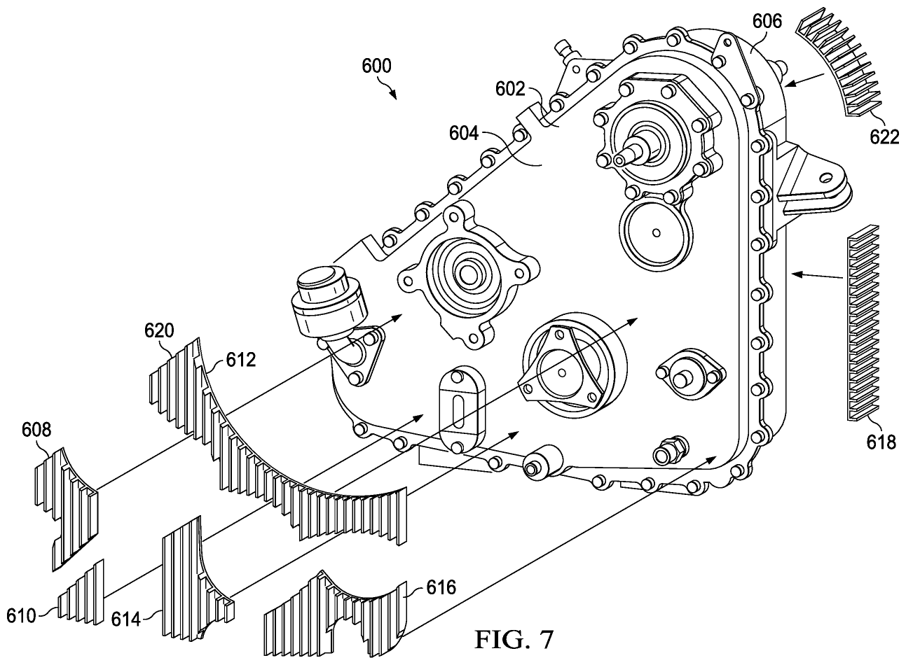

Referring to FIG. 7 in the drawings, a parallel axis gearbox is schematically illustrated and generally designated 600. Parallel axis gearbox 600 includes a gearbox housing 602 with both flat surfaces 604 and curved surfaces 606. Flat segmented gearbox cooling fin arrays 608, 610, 612, 614, 616, 618 are each uniquely shaped to cover the complex flat surfaces 604 of gearbox housing 602. Cooling fins 620 of segmented gearbox cooling fin arrays 608, 610, 612, 614, 616, 618 are parallel with one another, although in other embodiments cooling fins 620 may be splayed. Due to the relative ease with which to manufacture gearbox cooling fin arrays according to the illustrative embodiments, curved surfaces 606 of gearbox housing 602 also include one or more gearbox cooling fin arrays 622. Segmented gearbox cooling fin arrays 608, 610, 612, 614, 616, 618 and curved gearbox cooling fin array 622 may be bonded to gearbox housing 602 using a thermal interface material or other fastening technique.

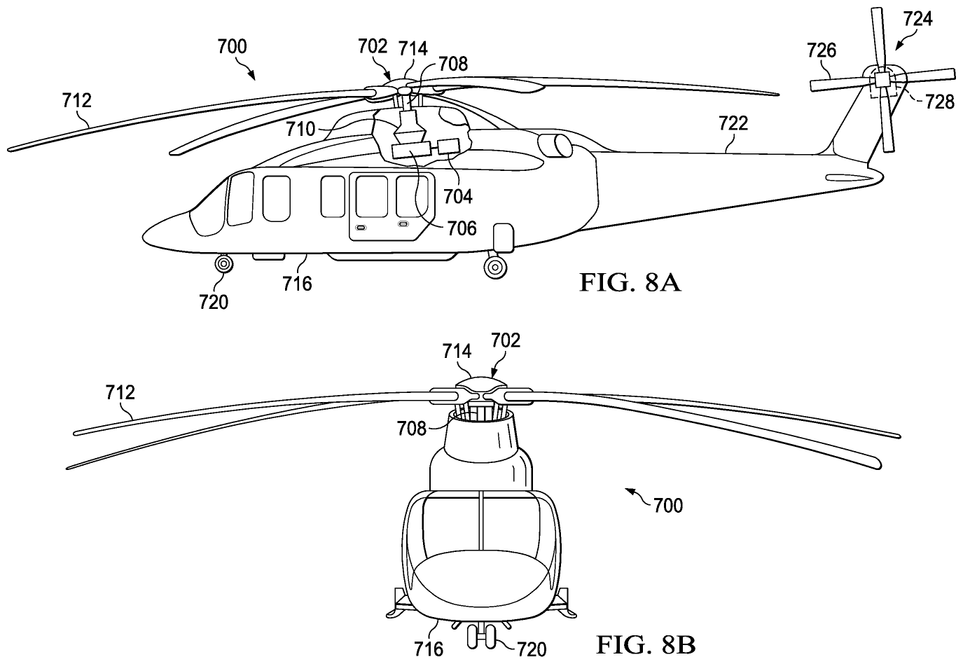

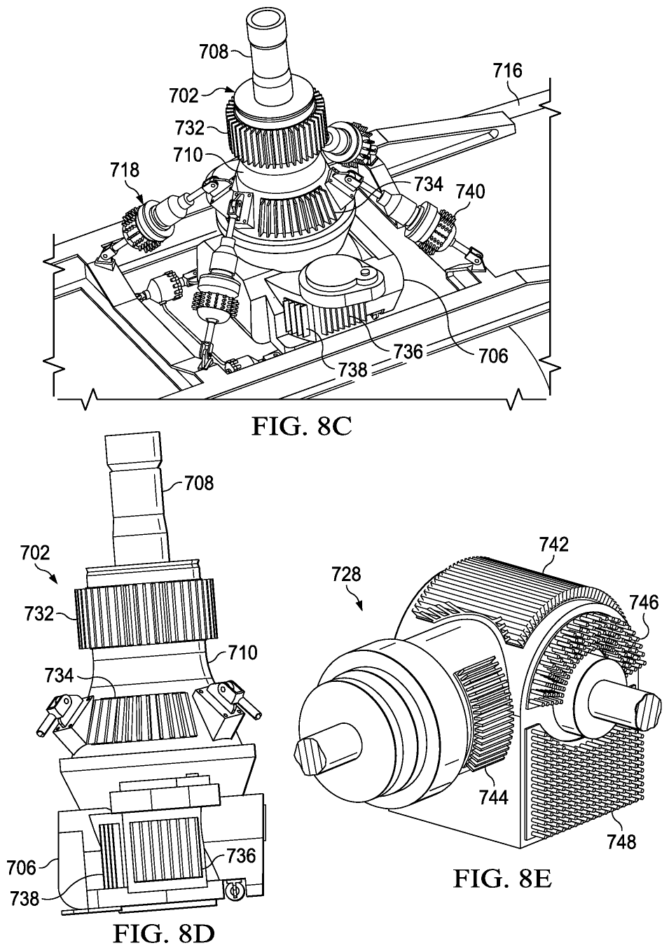

Referring to FIGS. 8A-8E in the drawings, a helicopter is schematically illustrated and generally designated 700. The primary propulsion assembly of helicopter 700 is a main rotor assembly 702 powered by an engine 704 via a main rotor gearbox 706. Mast 708 extends through a top case 710, which houses a mast bearing assembly to facilitate the stable rotation of mast 708. Main rotor assembly 702 includes a plurality of rotor blade assemblies 712 extending radially outward from a main rotor hub 714. Main rotor assembly 702 is coupled to a fuselage 716. A vibration isolation system 718 may be utilized to isolate the vibration of main rotor assembly 702 from fuselage 716 and the components and passengers therein. Main rotor hub 714 is rotatable relative to fuselage 716. The pitch of rotor blade assemblies 712 can be collectively and/or cyclically manipulated to selectively control direction, thrust and lift of helicopter 700. A landing gear system 720 provides ground support for helicopter 700. A tailboom 722 extends from fuselage 716 in the aft direction. An anti-torque system 724 includes a tail rotor 726 that is rotatably coupled to the aft portion of tailboom 722 via a tail rotor gearbox 728. Anti-torque system 724 controls the yaw of helicopter 700.

As best seen in FIGS. 8C-8D, curved cooling fin arrays 732, 734 are bonded to top case 710. Gearbox cooling fin arrays 736, 738 are bonded to main rotor gearbox 706. Cooling fin arrays 740 have also been applied to the vibration isolators of vibration isolation system 718. As best seen in FIG. 8E, curved gearbox cooling fin arrays 742, 744 partially cover curved surfaces of tail rotor gearbox 728. Flat gearbox cooling fin arrays 746, 748 partially cover flat surfaces of tail rotor gearbox 728. Indeed, the types of components and surface geometries on which cooling fin arrays of the illustrative embodiments may be applied are numerous.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A drivetrain for an aircraft comprising:
a gearbox including a gearbox housing;
a gearbox cooling fin array including a plurality of cooling fins; and
a thermal interface material bonding the gearbox cooling fin array to the gearbox housing;
wherein, the gearbox cooling fin array is configured to dissipate heat generated by the gearbox.

2. The drivetrain as recited in claim 1 wherein the gearbox further comprises a spiral bevel gearbox.

3. The drivetrain as recited in claim 1 wherein the gearbox housing forms a curved surface and the gearbox cooling fin array further comprises a curved gearbox cooling fin array to contour the curved surface of the gearbox housing.

4. The drivetrain as recited in claim 1 wherein the gearbox housing is formed from a different material than the gearbox cooling fin array.

5. The drivetrain as recited in claim 1 wherein the gearbox cooling fin array is formed from a more thermally conductive material than the gearbox housing.

6. The drivetrain as recited in claim 1 wherein the gearbox cooling fin array further comprises copper.

7. The drivetrain as recited in claim 1 wherein the gearbox cooling fin array further comprises an extruded gearbox cooling fin array.

8. The drivetrain as recited in claim 1 wherein the gearbox cooling fin array further comprises a flexible gearbox cooling fin array.

9. The drivetrain as recited in claim 1 wherein the gearbox cooling fin array further comprises a rigid gearbox cooling fin array.

10. The drivetrain as recited in claim 1 wherein the gearbox cooling fin array further comprises a plurality of segmented gearbox cooling fin arrays, each segmented gearbox cooling fin array bonded to the gearbox housing using the thermal interface material.

11. The drivetrain as recited in claim 1 wherein the plurality of cooling fins further comprise a plurality of pin fins.

12. The drivetrain as recited in claim 1 wherein the plurality of cooling fins further comprise splayed fins.

13. The drivetrain as recited in claim 1 wherein the plurality of cooling fins further comprise parallel fins.

14. The drivetrain as recited in claim 1 wherein the thermal interface material further comprises thermally conductive particulates.

15. The drivetrain as recited in claim 1 wherein the thermal interface material forms a bond line between the gearbox cooling fin array and the gearbox housing having a depth in a range between 0.005 inches and 0.01 inches.

16. A rotorcraft comprising:
a fuselage;
a rotor assembly coupled to the fuselage; and
a drivetrain providing rotational energy to the rotor assembly, the drivetrain comprising:
an engine;
a gearbox coupled to the engine, the gearbox including a gearbox housing;
a gearbox cooling fin array including a plurality of cooling fins; and
a thermal interface material bonding the gearbox cooling fin array to the gearbox housing;
wherein, the gearbox cooling fin array is configured to dissipate heat generated by the gearbox.

17. The rotorcraft as recited in claim 16 wherein the rotorcraft further comprises a tiltrotor aircraft further comprising:
a wing supported by the fuselage, the wing having outboard ends; and
first and second rotatable pylon assemblies coupled to the outboard ends of the wing;
wherein, the gearbox further comprises a spiral bevel gearbox located in one of the rotatable pylon assemblies.

18. The rotorcraft as recited in claim 16 wherein the gearbox further comprises a parallel axis gearbox.

19. The rotorcraft as recited in claim 16 wherein the gearbox further comprises a helicopter main rotor gearbox.

20. The rotorcraft as recited in claim 16 wherein the gearbox further comprises a tail rotor gearbox.
